(19) United States
(12) Patent Application Publication
(10) Pub. No.: US 2018/0101524 A1
(43) Pub. Date: Apr. 12, 2018

(54) SYSTEMS AND METHODS FOR CREATING AND DYNAMICALLY RENDERING USER-ADJUSTABLE CONTENT

(71) Applicant: Pragma Design, Inc., Bertam, TX (US)

(72) Inventor: Jeffrey C. Dunnihoo, Bertram, TX (US)

(21) Appl. No.: 15/730,577

(22) Filed: Oct. 11, 2017

Related U.S. Application Data
(60) Provisional application No. 62/407,332, filed on Oct. 12, 2016.

(51) Int. Cl. G06F 17/30; G06F 17/22; G06F 3/0484

(52) U.S. Cl. CPC G06F 17/3005; G06F 3/04847; G06F 17/30038; G06F 17/2247

(57) ABSTRACT

Disclosed are exemplary embodiments of systems for creating and dynamically rendering user-adjustable content. Also disclosed are exemplary embodiments of methods for creating and dynamically rendering user-adjustable content.

### CROSS-REFERENCE TO RELATED APPLICATION

This application claims the benefit and priority of U.S. Provisional Patent Application No. 62/407,332 filed Oct. 12, 2016. The entire disclosure of the above application is incorporated herein by reference.

### FIELD

The present disclosure relates to systems and methods for creating and dynamically rendering user-adjustable content.

### BACKGROUND

This section provides background information related to the present disclosure which is not necessarily prior art.

The Internet has become an invaluable source of information, news, entertainment, and commentary. The Internet has democratized information to such an extent that content consumers now have access to more information at their fingertips, and for little or no expense, than at any time in human history. Similarly, the barrier to entry for creating content online has dropped such that content created with almost no infrastructure or cost can “go viral” and rapidly eclipse the distribution reach of classical content providers, such as publishers, networks and news outlets.

### DRAWINGS

The drawings described herein are for illustrative purposes only of selected embodiments and not all possible implementations, and are not intended to limit the scope of the present disclosure.

FIG. 1 is a diagram of an example system for creating and dynamically rendering (e.g., displaying, broadcasting, webcasting, transmitting audio and/or video via the Internet, etc.) user-adjustable content;

FIG. 2 is an illustration of an example control panel for user-adjusting an article; and

FIG. 3 is a diagram that represents a simplified “data object” as a Python or JSON “list of dictionaries”.

Corresponding reference numerals indicate corresponding parts throughout the several views of the drawings.

### DETAILED DESCRIPTION

Example embodiments will now be described more fully with reference to the accompanying drawings.

The inventor hereof has recognized that with the expansion of Internet content, the signal-to-noise ratio has been affected significantly as opinions are mixed with fact, and fact is diluted with fiction. Taken on the whole, this landscape of ideas can be considered a “grand debate” at very large scales, encompassing broad swaths of conflicting perspectives and backgrounds. Unfortunately, information consumers tend to gravitate toward their preferred content conduits, which may skew or slant the information to a more limited perspective. Even if there could be a single completely legitimate, logical, rational and disinterested perspective on a particular topic to the exclusion of all others, it should still be of additional interest to the reader of Internet content that conflicting viewpoints are still held in contradiction, or that they have been held in the past as also completely legitimate, rational, etc. Hyperlinked footnotes for the author have dramatically reduced the consumer's effort required to branch off into supporting documents. But this can become a recursive search of footnotes on footnotes, which rapidly diffuses the focus on the original topic. On the other hand, dynamic comment sections have introduced the ability for consumers to provide feedback to authors and other consumers. Again, the focus and of course the quality of content becomes very difficult to manage.

The inventor has also observed that opinion and perception in a diverse community typically are biased based on different perspectives and backgrounds of the individual authors and readers. News and commentary made available on the Internet (probably the largest diverse community in history) has a strong tendency to prompt people to pigeonhole themselves into self-selected subsets of background bias, e.g., Fox News as opposed to MSNBC, or Salon as opposed to National Review, or the UK Daily Mail as opposed to the Financial Times, etc. Conversely, scientific study peer review development and delivery mechanisms, many of which were previously limited-access, are changing with the development of online open databases and resources, such as ResearchGate.com, opening up expertise and judgment (that previously often was siloed) of information to consumers having wider educational and experience backgrounds.

Many Internet resources are unidirectional, top-down information portals where a reader with additional information may silently think, “Yes, but they fail to mention . . . .” Initial attempts to address this limitation in the late 1990s and early 2000s prompted a return to the early bulletin board system (BBS) days of the Internet and to even earlier “letters-to-the-editor” sections of print publications, by the addition of comment sections directly below articles. Generally, though, original article content remained unchanged regardless of the reader interaction. Author bias and omissions generally remained, and any salient information discussed in the comments would often be drowned out by chatter, heated “flame wars,” and unrelated spam.

At least one online publisher, DrudgeReport.com, implemented a content aggregation layer method on top of this by simply linking comment-laden headlines to the target stories. Wiki's and Wikipedia.org, in particular, went much further to resolving the issue by creating a dynamic content backend with tracked, crowdsourced reviews that “evolved” the article, but this still renders only a currently accepted, community-moderated “snapshot” of a static article at any given time. Therefore, the result is a single static article compromised to the wishes of the winning authors and reviewers: those who have time and motivation to fight the flame wars on a specific topic.

Presently, the above-mentioned difficulties with comment sections have led to many articles locking comments (for example, at https://www.theguardian.com/science/brain-flapping/2014/sep/12/comment-sections-toxic-moderation), or removing the function altogether (for example, at http://www.nytimes.com/2013/09/22/magazine/no-comments.html). Another partial solution has been to dynamically link smaller comment section threads to specific elements within an article using a service, such as genius.com (https://www.washingtonpost.com/news/the-fix/wp/2016/06/24/donald-trumps-brexit-press-conference-was-beyond-bizarre/). This approach can be useful for discussion of particular song lyrics, and is similar to word processing document comments, but it can compound the problems of flame wars and spamming by instantiating multiple comment threads per article instead of one.

Accordingly, the inventor has developed and discloses herein exemplary embodiments of systems and methods for creating and characterizing topical communication content (e.g., text, images, audio, video, etc.), and for rendering a composite output selectively tuned according to the viewer's preferences. In some exemplary embodiments, one or more of the viewer preferences may be selected or input by the user, such as by using one or more slide controls of a control panel, etc. In some exemplary embodiments, one or more viewer preferences may be derived for the viewer indirectly (e.g., by profiling the viewer's browser or posting history, etc.). In some exemplary embodiments, one or more of the viewer's preferences may be predetermined, preloaded, preset, fixed, etc., such as by a web host or web hosting service that is hosting the website being accessed by a viewer, etc.

In various embodiments of the present disclosure, comments are not just linked, but are dynamically integrated into the body of an article. For content such as journals and document reviews, actual sample text can be offered for review and consideration by the viewer instead of suggestions or links to other findings, references and conclusions. For news portals, readers and consumers can choose the “slant” of the news and potentially offer alternate edits instead of mere comments. More importantly, readers can actively educate themselves on the fact that (1) any article can be written with wildly different perspectives and slants, and that (2) the version that makes sense to one person may be completely different than the one that makes sense to someone else.

Various embodiments make it possible for authors and editors to dynamically add additional information and/or new perspectives to an article without deleting previous slants, thereby allowing viewers to see the evolution of thought or fact. For example, biblical content has been rendered over time into myriad translations and variants. Normally, a reader would select the desired translation first, and then read the content framed as that single, continuous variant. In various embodiments of the present disclosure, this conceptual content tree can be expanded by providing a reader with instantaneous access to parallel variants of discretized (e.g., verses, sentences, words, etc.) content inline (e.g., translated text, historically relevant images, audio commentary, etc.). Similarly, articles in which opinion and fact are provided with regard to a given subject can have widely varying content and perspectives, even when the structures of the articles are nearly identical. In various embodiments of the present disclosure, a reader can instantly and interactively compare and contrast disparate perspectives within the dynamic rendering of content, instead of having to consume multiple distinct articles on the same topic.

In various system embodiments, content generation begins with an article or topic stub, either originated by the author or posted by a user, e.g., through a system client. Each article or unique topic includes a multitude of media elements, from basic words, sentences, paragraphs and sections, to graphical visualizations, images and audio/video segments. Each media element can be tagged with one or more qualitative and descriptive labels, and/or with a quantitative value of a range of values associated with the media element. Such tags may define points from a pre-defined range of diametric values (positive or negative product review) or a continuous multivariate economic-political map such as a “Nolan Chart.” Tags may also include tags or ratings from the user, moderator or authors, or even created algorithmically (such as with Kincaid analysis or AI deep-learning) from the content itself. A multitude of tags or sets of tags may be associated with media elements and stored in a central or distributed database, e.g., that system clients may access.

When a user consumes content, the set of media elements is rendered according to the settings of the user's client. Such settings may include multiple semi-permanent configuration options (such as explicit content limits), or they can be prominent select boxes and/or interactive slider controls manipulated in real-time by the consumer, or they may be automatically and algorithmically adjusted by media consumption tendencies of the consumer such as by profiling browser or posting history, etc. Changes in such settings may instantly or substantially instantly morph the rendered (e.g., concatenated, etc.) content viewed by the reader, allowing interactive comparison and contrasts by varying the settings. By way of example, the content may be concatenated from segments (e.g., alternate renderings of a paragraph, etc.) when one or more of the settings are changed. Or, for example, the content may be rendered by using an algorithm and/or artificial intelligence (AI) natural language processing (NLP) to create alternate renderings of a paragraph from diagrammed sentence elements when one or more of the settings are changed.

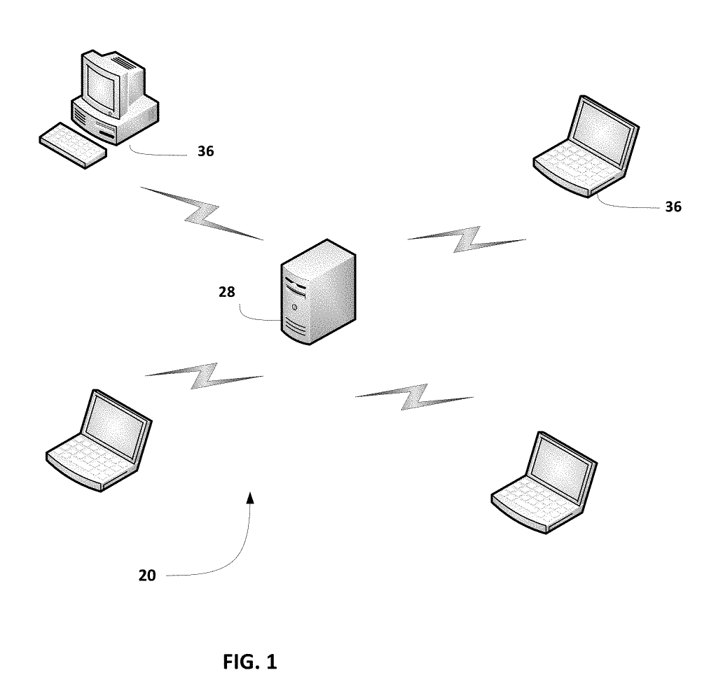

With reference now to the figures, FIG. 1 illustrates an example system 20 for creating and dynamically rendering (e.g., displaying, broadcasting, webcasting, transmitting audio and/or video via the Internet, etc.) user-adjustable content according to an exemplary embodiment embodying one or more aspects of the present disclosure. The example system 20 is a client-server system including one or more management computers 28 in communication via the Internet with a plurality of user computing devices 36, e.g., personal computers (e.g., laptop computers, notebook computers, etc.), tablets, smartphones, etc. In the present example embodiment, a single management computer 28 is shown. The management computer 28 is configured to perform as a web server and the user devices 36 are configured to perform as clients of the web server. The user devices 36, which can be considerably more numerous than four, as shown in FIG. 1, may be operated, e.g., by a plurality of authors, editors, readers, consumers, etc. Various embodiments thus may incorporate user, moderator and author account management and ranking systems. It will be understood by those knowledgeable in the art that various system features, functions and components may be provided in and/or by various numbers and/or configurations of computing and networking devices. Other or additional configurations of management and/or user devices and software could be used to provide a system for creating and dynamically displaying user-adjustable content. For example, in some embodiments, a system for creating and dynamically displaying user-adjustable content may be or include a distributed peer-to-peer system on the Internet.

The management computer 28 provides an application program interface (API) for access by the user devices 36. The management computer 28 also includes one or more application databases.

In the present example embodiment, one or more user devices 36 may execute a downloaded RESTful (Representational State Transfer) scripted content-rendering application, such as JavaScript, within a web browser. Users who are authenticated in the system 20 may expose various system capability views dependent on the type of authentication. In an example embodiment, a user who has not been authenticated in the system 20 may be allowed to interact with the system 20, but such interaction may be restricted to viewing-only. Users who have moderator or author accounts may create original and/or edit auto-generated or submitted topic stubs, which are then made available to client sites, e.g., as part of an index or content selection system. Stubs may be made available, e.g., through a push email alert, an index on a website, etc.

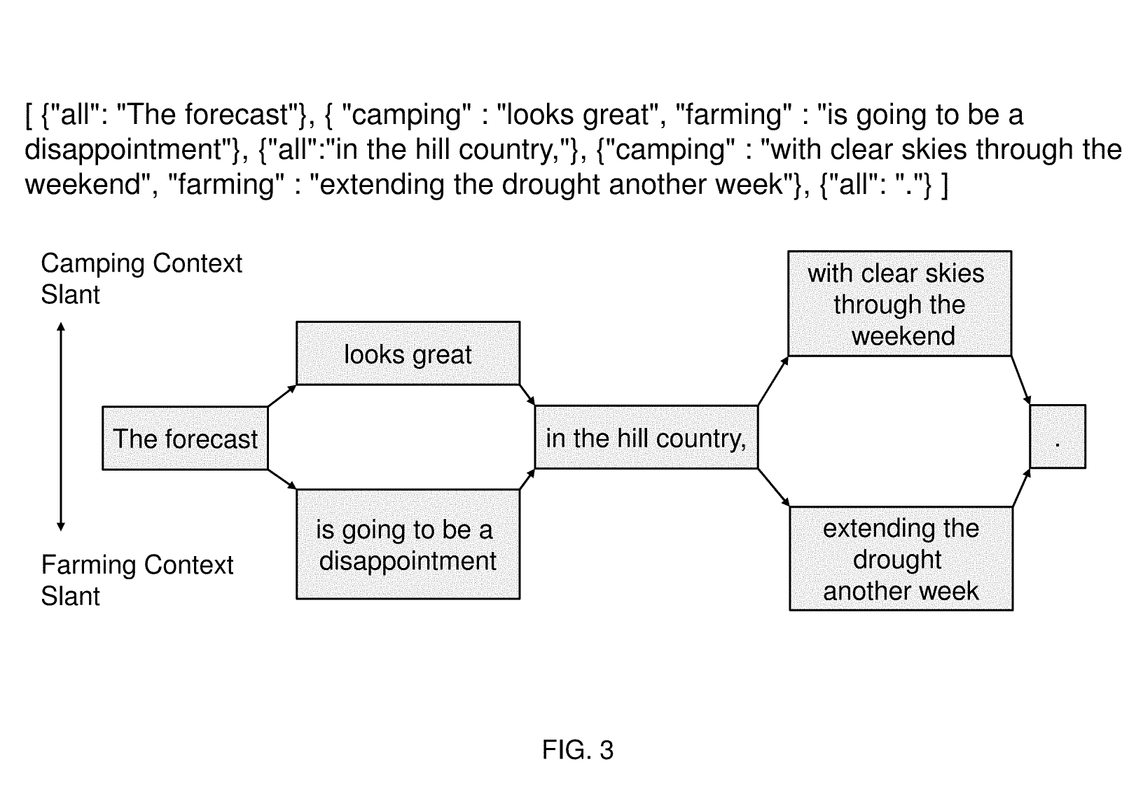

Clients on user devices 36 accessing the server API on the management computer 28 can receive authenticated, account-appropriate content in the form of a data object for a given topic. In various embodiments, the data object contains media elements (and/or arrays of variants of each media element) as well as selector and tag information for each media element variant type. The client application renders the topic along with default selector settings to the default (e.g., “neutral” or “basic”) static display. The user may then adjust the viewing settings, which cause the application to interactively recreate the content from the newly selected set of media elements. By way of example, FIG. 3 is a diagram that represents a simplified “data object” as a Python or JSON “list of dictionaries”.

If authorized, the client on a user device 36 may provide an edit and/or submission function to upload changes by the user, creating new media element variants. Such new media elements could be eventually collapsed into modifications of existing media elements by authorized users, or by the user himself, if so authorized. In various embodiments, a consistency check between a client and the server can indicate a need for a reloaded dataset, which the user may choose to continuously update as live changes are made, or may choose to manually update while working on a local snapshot of the dataset. Conflicts between modifications are generally handled by simply adding variants to the media element arrays. Merging and/or deletion of variants can be managed on the server side, and until then, the dynamic selection of the users continues to manage the selection.

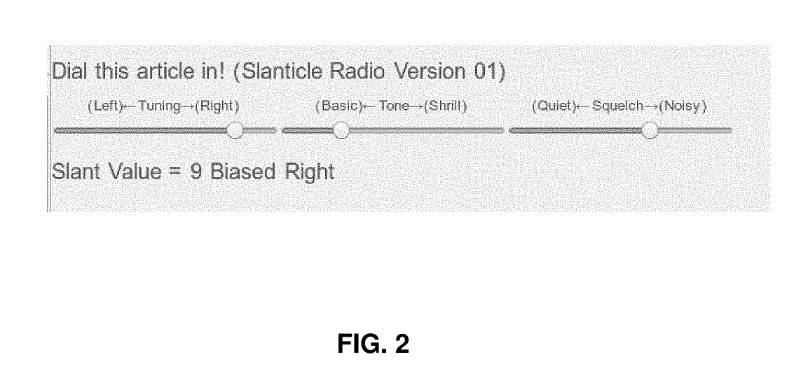

FIG. 2 illustrates an example embodiment of a control panel for adjusting a news article. The panel 100 provides three slider controls: a Tuning slider, a Tone slider, and a Squelch slider. The Tuning slider in the present example embodiment uses a simple “right/left” political metric. Other or additional sliders could include metrics for pro/con, for/against, etc. The definition of tags and controls can be made readily available to a reader (e.g., in a pop-up window, etc.) and may also be editable for certain authentication levels. In the present example embodiment, each media element array is divided within the selected scale. If there is only one media element option for a given segment (such as a simple sentence), then it is displayed no matter what “tuning” level is selected. In this example, the scales go to 11. If there are three variants (left, center, right), they might be divided between 0-3, 4-7 and 8-11. Other media elements might have more or less granular divisions, and thus, as the Tuning slider is moved, some media elements of the article may change rapidly and some media elements may change less or not at all, as viewed by the user.

The Tone slider may be moved between “basic” and “shrill.” The Tone control may use a global lexicon to replace words with “slanted” terms. The Tone control may also be used to replace slanted terms with more “basic” terms. So if a comment includes “Shrub” the Tone slider may cause it to revert back to “President Bush,” or vice versa. Controversial terms like “Pro-Life” may be translated to or from “Anti-Abortion,” etc.

The Squelch control could be implemented as a way to “bleep” explicit words or other gratuitous terms by fully omitting them at “quiet,” partially blanking the word (e.g., “S***”), or leaving it as is at “noisy.”

As an alternate implementation of “squelch”, each alternate variant of a media element or a tag can become another list within a list that can be managed. Such a list could include a registered reader's credentials with submissions, along with “upvote/downvote” counts, if implemented. The Squelch control could then “crowdsource” the “signal comments” from the “noise” versions by excluding the variants of media elements that fall below a selected rating level. This example approach differs dramatically from a “best rated” or “worst rated” sorting of a typical comment section in the prior art because it can dramatically change the character and content of an entire article instantly. The highest rated comments could eventually be integrated into “less noisy” renderings of the article, and still be dependent on the “tuning” slant.

Additionally, image choice (such as a prison mug shot, versus a smiling photo from childhood) can contribute to the perception of an article. Images and multimedia can be managed as inline media elements (as simply as HTML IMG tags, for example), so that they can change with the slider motion, too.

Color or highlighting can be added as shading in the text to show where there are changes (simple media elements that do not have multiple tuning variants submitted can be deemed ‘unbiased’ and remain monotone).

Various embodiments may incorporate dynamically and automatically generated article stubs, internal coherence and plagiarism detection algorithms and other content management utilities. Account management and ranking can provide quality control for content modification, to avoid problems common to static content such as spammers, automated bots, and undesirable and nonconstructive contributions, such as from “trolling.” In one embodiment for collaborative document revision, account management may be provided that is as simple as authentication for edits or approvals. Account management may be more complicated for content types, such as legal, technical or sales/marketing. For dynamically changing environments, such as world news, natural disasters and financial reporting, certain events or activities gleaned by automated bots and crawlers may be assembled as basic elements of a new article or topic that may be promoted by collective interest or moderated by special interests. For example, a marketing website that utilizes this technology for product reviews may filter stubs for only products which are stocked, or a scientific journal may move politically oriented stubs to a “legislative news” section. Original content protection and fair use of copyrighted excerpts can also be managed by validating appropriate linking and attribution. Also included are general article housekeeping functions, e.g., monitoring of article age and relevance. Account rankings, which may be developed, e.g., by content statistics and/or positive crowdsourcing feedback metrics, can be utilized to dynamically sift contributed media elements for value and/or popularity. Trusted contributors and/or valued content decisions can be applied as media element tags that can be selected by the consumer, or they can be used to retain desirable content and delete undesirable content at the source.

From a functionality perspective, various embodiments of the disclosure can provide a fully interactive user environment with intuitive controls, as opposed to a top-down, unidirectional content consumption experience.

The foregoing embodiments can incorporate alternative perspectives or “slants” dynamically into the information consumption process. Additionally, using embodiments described herein, consumers can annotate and provide feedback on their own “slant” dynamically inline, closing the content generation and maintenance loop (such as during a developing news story.) Quality control is addressed in various embodiments, where consumers and authors can dynamically moderate content creation and consumption in their personally rendered product. Author and moderator controls can dynamically create and edit content and, importantly, characterize and classify it, and consumers can render and submit content from their perspectives. Such process ultimately can be used to create a new type of archival content that captures a wider snapshot of diverse perspectives in many applications, from news reporting down to simple collaborative document editing and change review.

This also brings a potentially organizing (and perhaps more civilizing) framework to the “cage-match” Internet comment flame wars at the touch of a dial, allowing users to adjust the contrast and tone of content as easily as they change those controls on a television or radio.

Additionally, as communication modes proliferate and computational capabilities advance, embodiments of the present disclosure can also be applied to linear audio-video editing, especially in the area of documentaries. Raw footage and clips (or pointers to clips in other footage) can be managed as media element variations, and an output audiovisual stream can be compiled in real-time based on user controls. This would allow, for example, transition between MPAA (Motion Picture Association of America) rating levels of movies in real time, alternative plot lines, and/or dynamic viewpoints interjected in controversial documentaries.

An exemplary embodiment includes a system for creating and dynamically rendering user-adjustable content. The system generally includes at least one management computer configured to be operable as a web server for user devices operable as clients of the web server. The management computer is operable for providing an application program interface (API) for access by the user devices. The system is configured to be operable for providing the user devices with content including a data object having media elements and media element arrays of variants of the media elements with selector and tag information for media element variant types. The system is configured to be operable for rendering the content according to one or more settings and for interactively and dynamically recreating the content from a newly selected set of media elements in response to a change in the one or more settings.

The system may be operable for tagging or associating one or more tags with the media elements such that the media elements are tagged with one or more of a qualitative label, a descriptive label, and/or a quantitative value from a range of values associated with the media element. The media elements may comprise one or more of the following: words, sentences, sections, graphic visualizations, images, audio segments, and/or video segments.

The tags may define points from a predefined range of diametric values including one or more of a positive review, a negative review, and/or a continuous multivariate economic political map. The tags may include one or more ratings from one or more of a user, a moderator, and/or an author of the content. The tags may be automatically created algorithmically. The system may include a central or distributed database in which the tags associated with the media elements are stored and accessible to the user devices.

The system may be operable such that a set of media elements for content is rendered according to the one or more settings of a user device. The system may be operable to provide rendered or concatenated content to the user device when the one or more settings are changed, thereby allowing interactive comparison and contrast by varying the one or more settings.

The one or more settings may include one or more semi-permanent configuration options and/or explicit content limits, one or more user-selectable check boxes, one or more interactive slider controls configured to be manipulated in real-time by a user via a user device, one or more settings automatically and algorithmically adjusted by media consumption tendencies based on profiling browser history and/or posting history, and/or one or more settings predetermined and/or fixed.

One or more slider controls may be provided that are configured to be manipulated in real-time by a user via a user device to thereby allow the user to selectively adjust the one or more settings. The system may interactively and dynamically recreate the content from the newly selected set of media elements according to the one or more settings adjusted by the user via the one or more slider controls.

The one or more slider controls may comprise a tuning slider control for selecting a tuning level within a scale for the media element arrays that are divided within the scale, whereupon changing the tuning level via the tuning slider control, the system is operable for changing one or more of the media elements rapidly and/or for changing one or more of the media elements less or not at all depending on how the media element arrays are divided within the scale. The one or more slider controls may comprise a tone slider control for selecting a tone level, whereupon changing the tone level via the tone slider control, one or more words having a tone different than the selected tone level are replaced with one or more words consistent with the selected tone level. The one or more slider controls may comprise a squelch slider control for selecting a squelch level which allows content to be omitted or revised according to the selected squelch level.

The tuning slider control may be configured to allow a user to select a tuning level within a right/left political metric, a pro/con metric, or a for/against metric. The squelch slider control may be configured to allow a user to select a squelch level such that explicit content and gratuitous content is omitted or revised according to the selected squelch level. At least one of the one or more slider controls may be configured to allow a user to select a rating level. And, the system may be configured such that the system crowdsources comments from noise versions by excluding variants of media elements that fall below the selected rating level and/or by integrating highest rated comments into the content dependent on the selected tuning level.

The system may be operable such that images and multimedia are managed as inline media elements that are changeable via the one or more slider controls and/or such that shading in text is provided to show changes in the content.

The system may be configured to allow a user to provide, via a user device, an edit and/or a submission function to upload changes and to create new media element variants. The data object may comprise a Python or JSON list of dictionaries.

The system may be operable for creating and characterizing topical communication content including one or more of text, an image, audio, and/or video and rendering a composite output selectively tuned by one or more user inputs defining one or more user preferences.

The system may be operable for dynamically integrating directly into a body of text of the content a user's comments provided via a user device. The system may be operable for allowing a user to select from one or more user-selectable options of sample text to be dynamically integrated directly into a body of text of the content and/or to select a slant for the content and in response, the system provides alternate edits of the content.

The system may be operable for dynamically adding additional information and/or new perspectives to the content without deleting previous renderings of the content, thereby providing an evolution of the content by providing access to parallel variants of discretized content inline, and interactive comparing and contrasting of disparate perspectives within a dynamic rendering of the content.

The system may be configured to allow a user, via a user device, to adjust the one or more settings, whereby in response, the system interactively and dynamically recreates the content from the newly selected set of media elements according to the one or more settings adjusted by the user.

The system may configured to be operable as a client-server system. The system may be operable as a distributed peer-to-peer system on the Internet. At least one of the one or more settings may be predetermined and fixed.

The system may comprise means for rendering content according to the one or more settings, and means for interactively and dynamically recreating the content from the newly selected set of media elements in response to a change in the one or more settings.

The system may comprise a non-transitory computer-readable storage medium comprising code, which, when executed by a processor, causes the processor to perform operations for creating and dynamically rendering user-adjustable content, the operations performed by the processor when executing the code including rendering content according to the one or more settings, and interactively and dynamically recreating the content from the newly selected set of media elements in response to a change in the one or more settings.

An exemplary embodiment includes a system-performed method for creating and dynamically rendering user-adjustable content. The method generally includes rendering content according to one or more settings, the content including a data object having media elements and media element arrays of variants of the media elements with selector and tag information for media element variant types, and interactively and dynamically recreating the content from a newly selected set of media elements in response to a change in the one or more settings.

The method may include tagging or associating one or more tags with the media elements such that the media elements are tagged with one or more of a qualitative label, a descriptive label, and/or a quantitative value from a range of values associated with the media element. The media elements may comprise one or more of the following: words, sentences, sections, graphic visualizations, images, audio segments, and/or video segments.

The tagging or associating one or more tags with the media elements may comprise automatically creating the tags algorithmically. The tags may define points from a predefined range of diametric values including one or more of a positive review, a negative review, and/or a continuous multivariate economic political map. The tags may include one or more ratings from one or more of a user, a moderator, and/or an author of the content.

The method may include rendering a set of media elements for content according to the one or more settings, and providing rendered or concatenated content when the one or more settings are changed, thereby allowing interactive comparison and contrast by varying the one or more settings.

The method may include allowing a user to adjust one or more settings in real-time via a user device, and/or automatically and algorithmically adjusting one or more settings by media consumption tendencies by profiling browser history and/or posting history.

The method may include providing one or more slider controls configured to be manipulated in real-time by a user via a user device to thereby allow the user to selectively adjust the one or more settings; and interactively and dynamically recreating the content from the newly selected set of media elements according to the one or more settings adjusted by the user via the one or more slider controls.

The method may include allowing a user, via a user device to select a tuning level within a scale for the media element arrays that are divided within the scale and in response to a change in the tuning level, changing one or more of the media elements depending on how the media element arrays are divided within the scale; and/or a tone level, and in response to a change in tone level, replacing one or more words having a tone different than the selected tone level with one or more words consistent with the selected tone level; and/or a squelch level, and in response to a change in squelch level, omitting or revising content according to the selected squelch level.

The method may include selecting a rating level; and crowdsourcing comments from noise versions by excluding variants of media elements that fall below the selected rating level and/or by integrating highest rated comments into the content.

The method may include managing images and multimedia as inline media elements that are changeable by a user via a user device; and/or providing shading in text to show changes in the content; and/or creating and characterizing topical communication content including one or more of text, an image, audio, and/or video, and rendering a composite output selectively tuned by one or more user inputs defining one or more user preferences.

The method may include dynamically integrating directly into a body of text of the content one or more comments provided by a user via a user device; and/or allowing a user, via a user device, to select from one or more user-selectable options of sample text, and dynamically integrating the selected option of sample text directly into a body of text of the content, and/or to select a slant for the content and in response, providing alternate edits of the content.

The method may include dynamically adding additional information and/or new perspectives to the content without deleting previous renderings of the content, thereby allowing observation of an evolution of the content by providing parallel variants of discretized content inline, and interactive comparing and contrasting of disparate perspectives within a dynamic rendering of the content.

The method may include allowing a user, via a user device, to adjust the one or more settings; and interactively and dynamically recreating the content from the newly selected set of media elements according to the one or more settings adjusted by the user.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for creating and dynamically rendering user-adjustable content, the system comprising at least one management computer configured to be operable as a web server for user devices operable as clients of the web server, the management computer operable for providing an application program interface (API) for access by the user devices, the system configured to be operable for providing the user devices with content including a data object having media elements and media element arrays of variants of the media elements with selector and tag information for media element variant types, wherein the system is configured to be operable for rendering the content according to one or more settings and for interactively and dynamically recreating the content from a newly selected set of media elements in response to a change in the one or more settings.

2. The system of claim 1, wherein the system is operable for tagging or associating one or more tags with the media elements such that the media elements are tagged with one or more of a qualitative label, a descriptive label, and/or a quantitative value from a range of values associated with the media element, the media elements comprising one or more of the following: words, sentences, sections, graphic visualizations, images, audio segments, and/or video segments.

3. The system of claim 2, wherein:
the tags define points from a predefined range of diametric values including one or more of a positive review, a negative review, and/or a continuous multivariate economic political map; and/or
the tags include one or more ratings from one or more of a user, a moderator, and/or an author of the content; and/or
the tags are automatically created algorithmically; and/or
the system includes a central or distributed database in which the tags associated with the media elements are stored and accessible to the user devices.

4. The system of claim 1, wherein the system is operable such that a set of media elements for content is rendered according to the one or more settings of a user device, whereby the system is operable to provide rendered or concatenated content to the user device when the one or more settings are changed, thereby allowing interactive comparison and contrast by varying the one or more settings.

5. The system of claim 4, wherein the one or more settings include one or more of:
one or more semi-permanent configuration options and/or explicit content limits;
one or more user-selectable check boxes; and/or
one or more interactive slider controls configured to be manipulated in real-time by a user via a user device; and/or
one or more settings automatically and algorithmically adjusted by media consumption tendencies based on profiling browser history and/or posting history; and/or
one or more settings predetermined and/or fixed.

6. The system of claim 1, further comprising one or more slider controls configured to be manipulated in real-time by a user via a user device to thereby allow the user to selectively adjust the one or more settings such that the system interactively and dynamically recreates the content from the newly selected set of media elements according to the one or more settings adjusted by the user via the one or more slider controls.

7. The system of claim 6, wherein the one or more slider controls comprise:
a tuning slider control for selecting a tuning level within a scale for the media element arrays that are divided within the scale, whereupon changing the tuning level via the tuning slider control, the system is operable for changing one or more of the media elements rapidly and/or for changing one or more of the media elements less or not at all depending on how the media element arrays are divided within the scale; and/or
a tone slider control for selecting a tone level, whereupon changing the tone level via the tone slider control, one or more words having a tone different than the selected tone level are replaced with one or more words consistent with the selected tone level; and/or
a squelch slider control for selecting a squelch level which allows content to be omitted or revised according to the selected squelch level.

8. The system of claim 7, wherein:
the tuning slider control is configured to allow a user to select a tuning level within a right/left political metric, a pro/con metric, or a for/against metric; and/or
the squelch slider control is configured to allow a user to select a squelch level such that explicit content and gratuitous content is omitted or revised according to the selected squelch level; and/or
at least one of the one or more slider controls is configured to allow a user to select a rating level, and the system is configured such that the system crowdsources comments from noise versions by excluding variants of media elements that fall below the selected rating level and/or by integrating highest rated comments into the content dependent on the selected tuning level.

9. The system of claim 6, wherein the system is operable such that images and multimedia are managed as inline media elements that are changeable via the one or more slider controls and/or such that shading in text is provided to show changes in the content.

10. The system of claim 1, wherein:
the system is configured to allow a user to provide, via a user device, an edit and/or a submission function to upload changes and to create new media element variants; and/or
the data object comprises a Python or JSON list of dictionaries.

11. The system of claim 1, wherein the system is operable for creating and characterizing topical communication content including one or more of text, an image, audio, and/or video and rendering a composite output selectively tuned by one or more user inputs defining one or more user preferences.

12. The system of claim 1, wherein:
the system is operable for dynamically integrating directly into a body of text of the content a user's comments provided via a user device; and/or
the system is operable for allowing a user to select from one or more user-selectable options of sample text to be dynamically integrated directly into a body of text of the content and/or to select a slant for the content and in response, the system provides alternate edits of the content.

13. The system of claim 1, wherein the system is operable for dynamically adding additional information and/or new perspectives to the content without deleting previous renderings of the content, thereby providing an evolution of the content by providing access to parallel variants of discretized content inline, and interactive comparing and contrasting of disparate perspectives within a dynamic rendering of the content.

14. The system of claim 1, wherein the system is configured to allow a user, via a user device, to adjust the one or more settings, whereby in response, the system interactively and dynamically recreates the content from the newly selected set of media elements according to the one or more settings adjusted by the user.

15. The system of claim 1, wherein:
the system is configured to be operable as a client-server system; and/or
the system is operable as a distributed peer-to-peer system on the Internet; and/or
at least one of the one or more settings is predetermined and fixed.

16. The system of claim 1, comprising means for rendering content according to the one or more settings, and means for interactively and dynamically recreating the content from the newly selected set of media elements in response to a change in the one or more settings.

17. The system of claim 1 comprising a non-transitory computer-readable storage medium comprising code, which, when executed by a processor, causes the processor to perform operations for creating and dynamically rendering user-adjustable content, the operations performed by the processor when executing the code including rendering content according to the one or more settings, and interactively and dynamically recreating the content from the newly selected set of media elements in response to a change in the one or more settings.

18. A system-performed method for creating and dynamically rendering user-adjustable content, the method comprising:
rendering content according to one or more settings, the content including a data object having media elements and media element arrays of variants of the media elements with selector and tag information for media element variant types; and
interactively and dynamically recreating the content from a newly selected set of media elements in response to a change in the one or more settings.

19. The method of claim 18, wherein the method includes tagging or associating one or more tags with the media elements such that the media elements are tagged with one or more of a qualitative label, a descriptive label, and/or a quantitative value from a range of values associated with the media element, the media elements comprising one or more of the following: words, sentences, sections, graphic visualizations, images, audio segments, and/or video segments.

20. The method of claim 18, wherein:
tagging or associating one or more tags with the media elements comprises automatically creating the tags algorithmically; and/or
the tags define points from a predefined range of diametric values including one or more of a positive review, a negative review, and/or a continuous multivariate economic political map; and/or
the tags include one or more ratings from one or more of a user, a moderator, and/or an author of the content.

21. The method of claim 18, wherein the method includes:
rendering a set of media elements for content according to the one or more settings; and
providing rendered or concatenated content when the one or more settings are changed, thereby allowing interactive comparison and contrast by varying the one or more settings.

22. The method of claim 18, wherein the method includes:
allowing a user to adjust one or more settings in real-time via a user device; and/or
automatically and algorithmically adjusting one or more settings by media consumption tendencies by profiling browser history and/or posting history.

23. The method of claim 18, wherein the method includes:
providing one or more slider controls configured to be manipulated in real-time by a user via a user device to thereby allow the user to selectively adjust the one or more settings; and
interactively and dynamically recreating the content from the newly selected set of media elements according to the one or more settings adjusted by the user via the one or more slider controls.

24. The method of claim 18, wherein the method includes allowing a user, via a user device to select:
a tuning level within a scale for the media element arrays that are divided within the scale and in response to a change in the tuning level, changing one or more of the media elements depending on how the media element arrays are divided within the scale; and/or
a tone level, and in response to a change in tone level, replacing one or more words having a tone different than the selected tone level with one or more words consistent with the selected tone level; and/or
a squelch level, and in response to a change in squelch level, omitting or revising content according to the selected squelch level.

25. The method of claim 18, wherein the method includes:
selecting a rating level; and
crowdsourcing comments from noise versions by excluding variants of media elements that fall below the selected rating level and/or by integrating highest rated comments into the content.

26. The method of claim 18, wherein the method includes:
managing images and multimedia as inline media elements that are changeable by a user via a user device; and/or
providing shading in text to show changes in the content; and/or
creating and characterizing topical communication content including one or more of text, an image, audio, and/or video, and rendering a composite output selectively tuned by one or more user inputs defining one or more user preferences.

27. The method of claim 18, wherein the method includes:
dynamically integrating directly into a body of text of the content one or more comments provided by a user via a user device; and/or
allowing a user, via a user device, to select from one or more user-selectable options of sample text, and dynamically integrating the selected option of sample text directly into a body of text of the content, and/or to select a slant for the content and in response, providing alternate edits of the content.

28. The method of claim 18, wherein the method includes dynamically adding additional information and/or new perspectives to the content without deleting previous renderings of the content, thereby allowing observation of an evolution of the content by providing parallel variants of discretized content inline, and interactive comparing and contrasting of disparate perspectives within a dynamic rendering of the content.

29. The method of claim 18, wherein the method includes:
allowing a user, via a user device, to adjust the one or more settings; and
interactively and dynamically recreating the content from the newly selected set of media elements according to the one or more settings adjusted by the user.
